(19) United States
(12) Patent Application Publication
(10) Pub. No.: US 2026/0078914 A1
(43) Pub. Date: Mar. 19, 2026

(54) MOTOR DRIVE DEVICE, AIR-SENDING DEVICE, AIR-CONDITIONING APPARATUS, AND MOTOR DRIVING METHOD

(71) Applicant: Mitsubishi Electric Corporation, Tokyo (JP)

(72) Inventors: Kazunori SAKANOBE, Tokyo (JP); Daiki TANAKA, Tokyo (JP); Kosuke FUJITA, Tokyo (JP)

(21) Appl. No.: 19/102,708

(22) PCT Filed: Nov. 14, 2022
(86) PCT No.: PCT/JP2022/042181

§ 371 Date: Feb. 10, 2025

(51) Int. Cl. F24F 1/028

(52) U.S. Cl. CPC F24F 1/028

(57) ABSTRACT

A motor drive device includes: a first current sensor detects a first current signal indicating a current flowing to the first motor; a second current sensor that detects a second current signal indicating a current flowing to the second motor; a power converter; and a controller that controls the power converter by using a velocity command value, and control frequencies of the first and second motors. The controller includes: a coordinate transformer configured to obtain a first q-axis current estimate by using the first current signal and a first estimated phase, and that obtains a second q-axis current estimate by using the second current signal and a second estimated phase; and a compensator that compensates for the first estimated phase based on an estimated current difference between the first q-axis current estimate and the second q-axis current estimate to reduce a phase difference between the first and second motors.

### TECHNICAL FIELD

The present disclosure relates to a motor drive device that drives a plurality of motors, an air-sending device, an air-conditioning apparatus, and a motor driving method.

### BACKGROUND ART

As an existing device that drives a main-side synchronous motor and a sub-side synchronous motor that are connected parallel to a single inverter, a drive system that controls a magnetic flux current command to reduce a phase difference between the above two synchronous motors (see, for example, Patent Literature 1) has been known.

### CITATION LIST

### Patent Literature

Patent Literature 1: Japanese Unexamined Patent Application Publication No. 2021-106499

### SUMMARY OF INVENTION

### Technical Problem

However, a magnetic flux current cannot generate torque. Therefore, in the drive system disclosed in Patent Literature 1, even when a phase difference is made between the two synchronous motors, the two synchronous motors cannot be caused to generate torque to finely adjust their rotations. It is therefore impossible to reduce the phase difference. When the two synchronous motors continue operating, with the phase difference between the two synchronous motors made, a phase current of the sub-side synchronous motor is disturbed, and the operation of the sub-side synchronous motor is destabilized.

The present disclosure is applied to solve the above problems, and relates to a motor drive device, an air-sending device, an air-conditioning apparatus, and a motor driving method that improve the stability of the operation of a sub-motor of two motors connected parallel to a single power converter.

### Solution to Problem

A motor drive device according to one embodiment of the present disclosure is a motor drive device that drives a first motor and a second motor. The motor drive device includes: a first current sensor configured to detect a first current signal indicating a current that flows to the first motor; a second current sensor configured to detect a second current signal indicating a current that flows to the second motor, a power converter to which the first motor and the second motor are connected in parallel, the power converter being configured to supply power to the first motor and the second motor; and a controller configured to control the power converter by using a velocity command value, and control frequencies of the first motor and the second motor. The controller includes: a coordinate transformer configured to obtain a first q-axis current estimate that is an estimate of a torque current of the first motor, by using the first current signal and a first estimated phase that is an estimate of a phase of the first motor, and configured to obtain a second q-axis current estimate that is an estimate of a torque current of the second motor, by using the second current signal and a second estimated phase that is an estimate of a phase of the second motor; and a compensator configured to compensate for the velocity command value, a q-axis current command value of the first motor, or the first estimated phase on the basis of an estimated current difference between the first q-axis current estimate and the second q-axis current estimate to reduce a phase difference between the first motor and the second motor.

An air-sending device according to another embodiment of the present disclosure includes: a first motor to which a first fan is coupled; a second motor to which a second fan is coupled; and the motor drive device configured to drive the first motor and the second motor.

An air-conditioning apparatus according to still another embodiment of the present disclosure includes: a refrigerant circuit in which a compressor, a heat-source-side heat exchanger, an expansion valve, and a load-side heat exchanger are connected by refrigerant pipes and in which refrigerant circulates; and the air-sending device configured to supply air to at least one of the heat-source-side heat exchanger and the load-side heat exchanger.

A motor driving method according to yet another embodiment of the present disclosure is a motor driving method using a motor drive device that includes: a power converter to which a first motor and a second motor are connected in parallel, the power converter being configured to supply power to the first motor and the second motor; a first current sensor configured to detect a first current signal indicating a current that flows to the first motor; and a second current sensor configured to detect a second current signal indicating a current that flows to the second motor, the motor drive device being configured to control the power converter by using a velocity command value and control frequencies of the first motor and the second motor. The motor driving method includes: obtaining a first q-axis current estimate that is an estimate of a torque current of the first motor, by using the first current signal and a first estimated phase that is an estimate of a phase of the first motor; obtaining a second q-axis current estimate that is an estimate of a torque current of the second motor, by using the second current signal and a second estimated phase that is an estimate of a phase of the second motor; and compensating for the velocity command value and a q-axis current command value or the first estimated phase of the first motor based on an estimated current difference between the first q-axis current estimate and the second q-axis current estimate to reduce a phase difference between the first motor and the second motor.

### Advantageous Effects of Invention

In the embodiments of the present disclosure, the velocity command value, the q-axis current command value of the first motor, or the phase of the first motor is compensated for on the basis of the estimated current difference between the q-axis current estimate of the first motor and the q-axis current estimate of the second motor, thereby reducing the phase difference between the first motor and the second motor. Thus, a phase shift of the second motor relative to the first motor is eliminated. In the second motor, occurrence of disturbances in a phase current is reduced, thus improving the stability of the operation of the second motor.

### BRIEF DESCRIPTION OF DRAWINGS

FIG. 1 illustrates a configuration example of a motor drive device according to Embodiment 1.

FIG. 2 illustrates a configuration example of a power converter as illustrated in FIG. 1.

FIG. 3 is a block diagram illustrating a configuration example of a controller as illustrated in FIG. 1.

FIG. 4 is a hardware configuration diagram illustrating a configuration example of the controller as illustrated in FIG. 3.

FIG. 5 is a hardware configuration diagram illustrating another configuration example of the controller as illustrated in FIG. 3.

FIG. 6 is a flowchart indicating the procedure of an operation of the motor drive device according to Embodiment 1.

FIG. 7 is a graph illustrating the waveform of the frequency of a second motor under control in a comparative example.

FIG. 8 is a graph illustrating the waveform of a phase current of the second motor under control in the comparative example.

FIG. 9 is a graph illustrating the waveform of the frequency of the second motor under control according to Embodiment 1.

FIG. 10 is a graph illustrating the waveform of a phase current of the second motor under control according to Embodiment 1.

FIG. 11 is a block diagram illustrating a configuration example of a controller of a motor drive device according to Embodiment 2.

FIG. 12 is a block diagram illustrating a configuration example of a controller of a motor drive device according to Embodiment 3.

FIG. 13 is a refrigerant circuit diagram illustrating a configuration example of an air-conditioning apparatus according to Embodiment 4.

### DESCRIPTION OF EMBODIMENTS

### Embodiment 1

In Embodiment 1, q-axis currents of a plurality of motors are estimated, and a velocity command value is compensated for based on the results of this estimation, thereby stabilizing the synchronous operation of the plurality of motors.

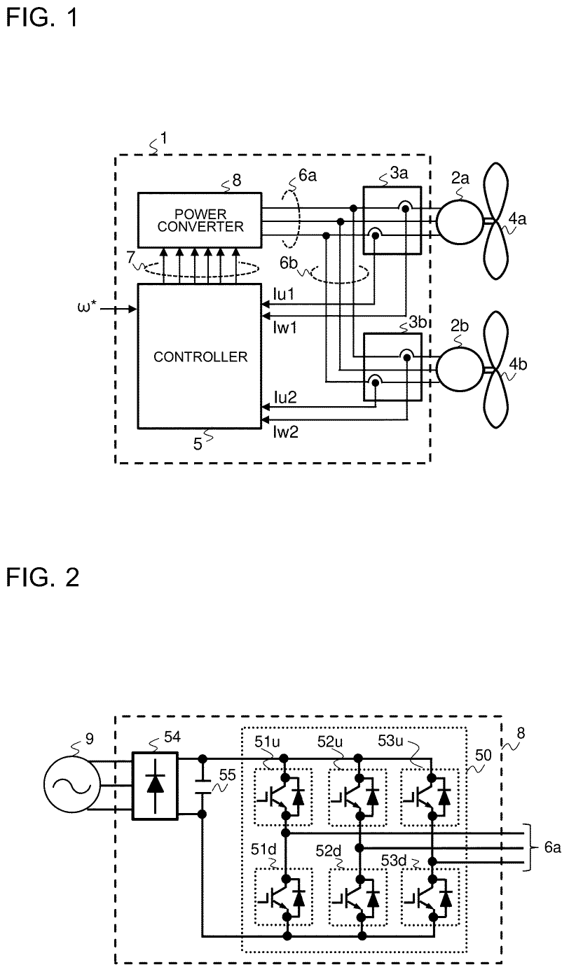

A configuration of a motor drive device according to Embodiment 1 will be described. FIG. 1 illustrates a configuration example of the motor drive device according to Embodiment 1. As illustrated in FIG. 1, a first motor 2a and a second motor 2b are connected to a motor drive device 1. In the first motor 2a, a first fan 4a is coupled to a rotating shaft of the first motor 2a. In the second motor 2b, a second fan 4b is coupled to a rotating shaft of the second motor 2b.

The first fan 4a is a load on the first motor 2a. The second fan 4b is a load on the second motor 2b. The first motor 2a and the second motor 2b are alternating-current synchronous motors. The first motor 2a and the second motor 2b are, for example, permanent magnet (PM) synchronous motors.

The motor drive device 1 includes a power converter 8, a first current sensor 3a, a second current sensor 3b, and a controller 5. The first motor 2a is connected to the power converter 8 by a first conductive wire 6a. At the first conductive wire 6a, the first current sensor 3a is provided to detect a motor current that flows to the first motor 2a.

A second conductive wire 6b branches off from part of the first conductive wire 6a that is located between the power converter 8 and the first current sensor 3a, and is connected to the second motor 2b. The first motor 2a and the second motor 2b are connected in parallel to the power converter 8 by the first conductive wire 6a and the second conductive wire 6b. At the second conductive wire 6b, the second current sensor 3b is provided to detect a motor current that flows to the second motor 2b.Each of the first conductive wire 6a and the second conductive wire 6b includes three lines that allow three-phase motor currents, that is, U-phase, V-phase, and W-phase currents, to pass therethrough, respectively.

The controller 5 controls the power converter 8 by using a velocity command value ω* input from an external host device (not illustrated) to control frequencies of the first motor 2a and the second motor 2b. The velocity command value ω* determines the frequencies of the first motor 2a and the second motor 2b. A voltage that is applied to the first motor 2a and the second motor 2b is controlled by a pulse width modulation (PWM) signal output from the controller 5 through a signal line 7.

The first current sensor 3a detects a current signal Iu1 indicating a U-phase motor current of the first motor 2a and a current signal Iw1 indicating a W-phase motor current of the first motor 2a. The second current sensor 3b detects a current signal Iu2 indicating a U-phase motor current of the second motor 2b and a current signal Iw2 indicating a W-phase motor current of the second motor 2b.

FIG. 2 illustrates a configuration example of the power converter as illustrated in FIG. 1. The power converter 8 is controlled by the controller 5 to supply power corresponding to the velocity command value ω* to the first motor 2a and the second motor 2b.

The power converter 8 includes an inverter circuit 50 and a rectifier circuit 54 connected to an alternating-current power supply 9. The inverter circuit 50 includes a plurality of switching elements 51u to 53u and 51d to 53d that convert a direct-current voltage output from the rectifier circuit 54 into a three-phase alternating-current voltage and apply the three-phase alternating-current voltage to the first motor 2a and the second motor 2b. The rectifier circuit 54 converts an alternating-current voltage applied from the alternating-current power supply 9 into a direct-current voltage. The rectifier circuit 54 is, for example, a diode-bridge circuit. As illustrated in FIG. 2, a capacitor 55 may be connected between direct-current buses. The capacitor 55 smooths and stabilizes a direct-current voltage.

In the inverter circuit 50, a pair of switching elements is provided for each of the U, V, and W phases. As for the U phase, the switching element 51u of an upper arm and the switching element 51d of a lower arm are connected in series. A connection point between the switching element 51u and the switching element 51d is connected to a U-phase input terminal of the first motor 2a by the first conductive wire 6a and is connected to a U-phase input terminal of the second motor 2b by the first conductive wire 6a and the second conductive wire 6b.

As for the V phase, the switching element 52u of the upper arm and the switching element 52d of the lower arm are connected in series. A connection point between the switching element 52u and the switching element 52d is connected to a V-phase input terminal of the first motor 2a by the first conductive wire 6a and is connected to a V-phase input terminal of the second motor 2b by the first conductive wire 6a and the second conductive wire 6b. As for the W phase, the switching element 53u of the upper arm and the switching element 53d of the lower arm are connected in series. A connection point between the switching element 53u and the switching element 53d is connected to a W-phase input terminal of the first motor 2a by the first conductive wire 6a and is connected to a W-phase input terminal of the second motor 2b by the first conductive wire 6a and the second conductive wire 6b.

To each of the plurality of switching elements 51u to 53u and 51d to 53d, a reverse current protection element is provided in anti-parallel. Each switching element is, for example, an Insulated gate bipolar transistor (IGBT) or a metal oxide semiconductor filed effect transistor (MOSFET).

These plurality of switching elements 51u to 53u and 51d to 53d perform a switching operation based on a PWM control method. The plurality of switching elements 51u to 53u and 51d to 53d perform a switching operation in response to a PWM signal that is input from the controller 5 to gate electrodes. Through this switching operation, the inverter circuit 50 converts a direct-current voltage into a three-phase alternating-current voltage of a frequency that is appropriate for driving of the first motor 2a and the second motor 2b, and applies the three-phase alternating-current voltage to those two motors.

Although FIG. 2 illustrates the case where the power converter 8 converts a single-phase alternating-current voltage applied from the alternating-current power supply 9 into a direct-current voltage, the alternating-current voltage to be applied may be a three-phase alternating-current voltage. Furthermore, the inverter circuit 50 may also be connected to a direct-current power supply such as a battery. In this case, a direct-current voltage applied from the direct-current power supply is used to generate a three-phase alternating-current voltage.

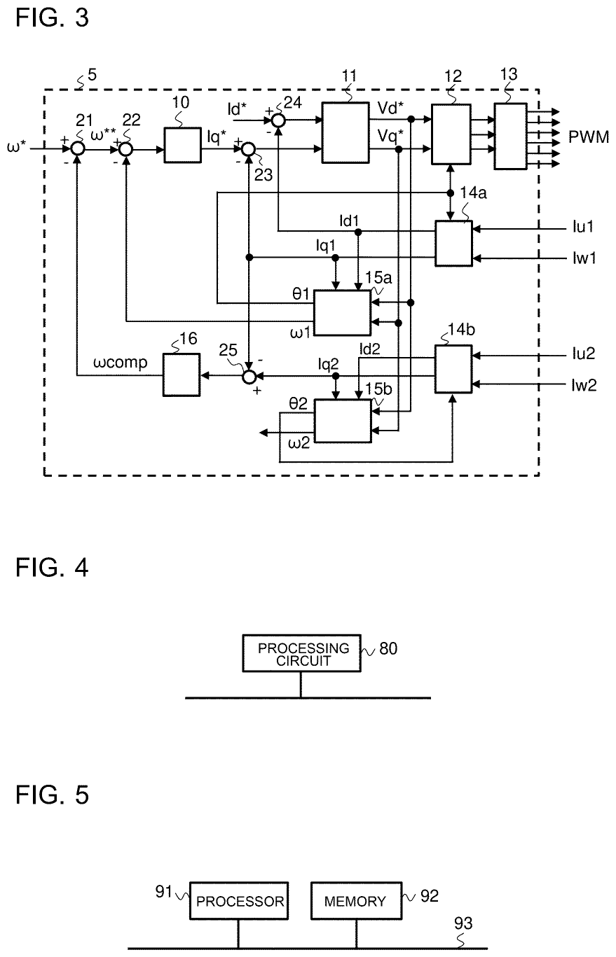

Next, a configuration of the controller 5 will be described with reference to FIG. 3. FIG. 3 is a block diagram illustrating a configuration example of the controller as illustrated in FIG. 1. The controller 5 includes a velocity controller 10, a current controller 11, an inverse coordinate transformer 12, a PWM signal generation unit 13, a coordinate transformer 14a, a coordinate transformer 14b, a position-velocity estimator 15a, a position-velocity estimator 15b, and a compensator 16. Furthermore, the controller 5 includes subtracters 21 to 25.

The coordinate transformer 14a obtains first current signals (Iu1, Iw1, Iv1) by using current signals Iu1 and Iw1 detected by the first current sensor 3a and a relational equation Iu1+Iv1+Iw1=0. The coordinate transformer 14a receives an estimated phase θ1 that is an estimate of a phase of the first motor 2a, from the position-velocity estimator 15a. The coordinate transformer 14a obtains dq-axis current values (Id1, Iq1) by using the first current signals (Iu1, Iv1, Iw1) and the estimated phase θ1. A d-axis current estimate Id1 is an estimate of a d-axis current corresponding to an exciting current of the first motor 2a. A q-axis current estimate Iq1 is an estimate of a q-axis current corresponding to a torque current of the first motor 2a.

The coordinate transformer 14a outputs the d-axis current estimate Id1 to the subtracter 24 and the position-velocity estimator 15a. The coordinate transformer 14a outputs the q-axis current estimate Iq1 to the subtracters 23 and 25 and the position-velocity estimator 15a.

The coordinate transformer 14b obtains second current signals (Iu2, Iw2, Iv2) by using current signals Iu2 and Iw2 detected by the second current sensor 3b and a relational equation Iu2+Iv2+Iw2=0. The coordinate transformer 14b receives an estimated phase θ2 that is an estimate of a phase of the second motor 2b, from the position-velocity estimator 15b. The coordinate transformer 14b obtains dq-axis current values (Id2, Iq2) by using the second current signals (Iu2, Iv2, Iw2) and the estimated phase θ2. A d-axis current estimate Id2 is an estimate of a d-axis current corresponding to an exciting current of the second motor 2b. A q-axis current estimate Iq2 is an estimate of a q-axis current corresponding to a torque current of the second motor 2b.

The coordinate transformer 14b outputs the d-axis current estimate Id2 to the position-velocity estimator 15b. The coordinate transformer 14b outputs the q-axis current estimate Iq2 to the subtracter 25 and the position-velocity estimator 15b.

The position-velocity estimator 15a receives the dq-axis current values (Id1, Iq1) from the coordinate transformer 14a and receives dq-axis voltage command values (Vd*, Vq*) from the current controller 11. The position-velocity estimator 15a obtains an estimated velocity ω1 that is an estimate of an angular velocity of the first motor 2a and an estimated phase θ1 of the first motor 2a, by using the d-axis current estimate Id1 and the q-axis current estimate Iq1 and also the d-axis voltage command value Vd* and the q-axis voltage command value Vq*. The position-velocity estimator 15a outputs the estimated phase θ1 to the inverse coordinate transformer 12 and the coordinate transformer 14a. The position-velocity estimator 15a outputs the estimated velocity ω1 to the subtracter 22.

The position-velocity estimator 15b receives the dq-axis current values (Id2, Iq2) from the coordinate transformer 14b and receives dq-axis voltage command values (Vd*, Vq*) from the current controller 11. The position-velocity estimator 15b obtains an estimated velocity ω2 of the second motor 2b and an estimated phase θ2 of the second motor 2b by using the d-axis current estimate Id2 and the q-axis current estimate Iq2 and also the d-axis voltage command value Vd* and the q-axis voltage command value Vq*. The position-velocity estimator 15b outputs the estimated phase θ2 to the coordinate transformer 14b. Although the position-velocity estimator 15b outputs the estimated velocity ω2 as illustrated in FIG. 3, the estimated velocity ω2 is not used in the control according to Embodiment 1. Thus, the position-velocity estimator 15b does not need to obtain the estimated velocity ω2.

When the q-axis current estimate Iq1 is input from the coordinate transformer 14a and the q-axis current estimate Iq2 is input from the coordinate transformer 14b, the subtracter 25 calculates (Iq2−Iq1) and outputs the calculated result to the compensator 16. Hereinafter, it is assumed that Iq2−Iq1=ΔIq, and ΔIq will be referred to as a motor-to-motor current difference. The subtracter 25 outputs the value of the motor-to-motor current difference ΔIq to the compensator 16.

When a velocity compensation value ωcomp is input from the compensator 16, the subtracter 21 subtracts the velocity compensation value ωcomp from the velocity command value ω* to obtain a corrected velocity command value ω** that is a corrected velocity command value. The subtracter 21 outputs the corrected velocity command value ω** to the subtracter 22. When the corrected velocity command value ω** is input from the subtracter 21 and the estimated velocity ω1 is input from the position-velocity estimator 15a, the subtracter 22 obtains a velocity difference Δw that is the difference between the corrected velocity command value ω** and the estimated velocity ω1, and outputs the value of the velocity difference Δw to the velocity controller 10.

When the velocity difference Δw is input from the subtracter 22, the velocity controller 10 performs feedback control in which an output is integrated such that the velocity difference Δw reaches zero. Specifically, the velocity controller 10 performs a proportional integral (PI) control to obtain a q-axis current command value Iq* that causes the velocity difference Δw to decrease. The q-axis current command value Iq* is a command value of a q-axis current. The velocity controller 10 outputs the q-axis current command value Iq* to the subtracter 23.

When the q-axis current command value Iq* is input from the velocity controller 10 and the q-axis current estimate Iq1 is input from the coordinate transformer 14a, the subtracter 23 subtracts the q-axis current estimate Iq1 from the q-axis current command value Iq* to obtain a q-axis current difference ΔIq1. That is, the subtracter 23 calculates the result of the equation ΔIq1=Iq*−Iq1. The subtracter 23 outputs the value of the q-axis current difference ΔIq1 to the current controller 11.

When a d-axis current command value Id* that is a command value of a d-axis current is input and the d-axis current estimate Id1 is input from the coordinate transformer 14a, the subtracter 24 subtracts the d-axis current estimate Id1 from the d-axis current command value Id* to obtain a d-axis current difference ΔId1. That is, the subtracter 24 calculates the result of the equation ΔId1=Id*−Id1. The subtracter 24 outputs the d-axis current difference ΔId1 to the current controller 11. Regarding Embodiment 1, the following description is made with respect to the case where the d-axis current command value Id* is a constant value. The d-axis current command value Id* may be output from an electric circuit (not illustrated) provided in the controller 5, such as a storage, or may be input from the outside of the controller 5.

When the q-axis current difference ΔIq1 is input from the subtracter 23 and the d-axis current difference ΔId1 is input from the subtracter 24, the current controller 11 performs feedback control in which an output is integrated such that each of the q-axis current difference ΔIq1 and the d-axis current difference ΔId1 reaches zero. Specifically, the current controller 11 performs PI control to obtain dq-axis voltage command values (Vd*, Vq*) that reduce the d-axis current difference ΔId1 and the q-axis current difference ΔIq1, respectively. Vd* is a d-axis voltage command value, and Vq* is a q-axis voltage command value. The current controller 11 outputs the dq-axis voltage command values (Vd*, Vq*) to the position-velocity estimator 15a, the position-velocity estimator 15b, and the inverse coordinate transformer 12.

The inverse coordinate transformer 12 receives the dq-axis voltage command values (Vd*, Vq*) from the current controller 11 and receives the estimated phase θ1 of the first motor 2a from the position-velocity estimator 15a. The inverse coordinate transformer 12 performs coordinate transformation of the dq-axis voltage command values (Vd*, Vq*) into three-phase voltages (Vu, Vv, Vw) by using the estimated phase θ1. The inverse coordinate transformer 12 outputs the three-phase voltages (Vu, Vv, Vw) to the PWM signal generation unit 13.

When the three-phase voltages (Vu, Vv, Vw) are input from the inverse coordinate transformer 12 and the estimated phase θ1 is input from the position-velocity estimator 15a, the PWM signal generation unit 13 generates PWM signals. The PWM signal generation unit 13 outputs the generated PWM signals to the power converter 8.

When the value of the motor-to-motor current difference ΔIq is input from the subtracter 25, the compensator 16 obtains a velocity compensation value ωcomp that eliminates a phase shift between the motors. For example, the compensator 16 obtains, based on the value of the motor-to-motor current difference ΔIq, the amount of transient change as in a high pass filter, and performs amplification by the obtained amount of change to obtain a velocity compensation value ωcomp. The compensator 16 outputs the velocity compensation value ωcomp to the subtracter 21.

The operation of the compensator 16 is expressed, for example, by a transfer function G1(s) in Equation (1). The transfer function G1(s) is obtained by combining a high pass filter having a determined time constant T and an amplifier having a determined gain K.

$$Math . 1$$

$${G}_{1} ( s ) = \frac{{KT}_{s}}{1 - {T}_{s}} ( {I}_{q 2} - {I}_{q 1} ) \qquad ( 1 )$$

A polarity relationship in which the polarity of the velocity compensation value ωcomp that is output from the compensator 16 is positive when the right side (Iq2−Iq1) of Equation (1) is positive is established. That is, when the motor-to-motor current difference ΔIq (=Iq2−Iq1) is positive, the velocity compensation value ωcomp is also a positive value.

The operation of the compensator 16 will be specifically described. For example, the case where the motor-to-motor current difference ΔIq is positive refers to a condition in which the q-axis current estimate Iq2 is greater than the q-axis current estimate Iq1. In this case, a larger load torque can be considered to be transiently applied on the second motor 2b than on the first motor 2a. Since these two motors are given the same voltage, it can be presumed that the rotational phase of the second motor 2b transiently changes with a transient lag. It is possible to relatively eliminate the phase lag by transiently reducing a frequency command of the inverter circuit 50. Therefore, the compensator 16 outputs the velocity compensation value ωcomp of a positive value to the subtracter 21. Thus, the corrected velocity command value ω** decreases, and an output frequency of the inverter circuit 50 decreases. Since the load on the first motor 2a is smaller than that on the second motor 2b, a phase change of the first motor 2a is relatively small with respect to a variation in the output frequency of the inverter circuit 50. As a result, the difference between the phase of the second motor 2b and that of the first motor 2a decreases, and the phase lag of the second motor 2b is eliminated.

By contrast, the case where the motor-to-motor current difference ΔIq is negative refers to a condition in which the q-axis current estimate Iq2 is smaller than the q-axis current estimate Iq1. That is, the load torque on the second motor 2b is relatively smaller than that on the first motor 2a. In this case, it can be presumed that the phase of the second motor 2b relatively advances. Therefore, the compensator 16 outputs the velocity compensation value ωcomp of a negative value to the subtracter 21. Thus, the corrected velocity command value ω** transiently increases, and the output frequency of the inverter circuit 50 increases. Since the load on the second motor 2b is smaller than that on the first motor 2a, a phase change of the second motor 2b is relatively small with respect to a variation in the output frequency of the inverter circuit 50. As a result, the difference between the phase of the second motor 2b and that of the first motor 2a decreases, and the phase advance of the second motor 2b is eliminated. The compensator 16 performs such a frequency compensation operation as described above continuously at fixed time intervals to stabilize the synchronous operation of the second motor 2b.

In Embodiment 1, as described above, the controller 5 controls the frequency of the first motor 2a through position sensorless vector control, and causes the frequency of the second motor 2b to be subjected to compensation control by the compensator 16. The first motor 2a corresponds to a primary motor serving as the reference for an object to be velocity-controlled. The second motor 2b corresponds to a sub-motor that operates in synchronization with the primary motor.

Although FIG. 3 illustrates a configuration in which two coordinate transformation units, that is, the coordinate transformers 14a and 14b, are provided as separate units, a single coordinate transformation unit having functions of both the coordinate transformers 14a and 14b may be provided in the controller 5. Furthermore, although FIG. 3 illustrates a configuration in which position-velocity estimation units, such as the position-velocity estimators 15a and 15b, are provided as separate units, a single position-velocity estimation unit having functions of the position-velocity estimators 15a and 15b may be provided in the controller 5.

Furthermore, regarding Embodiment 1, although the above description is made with respect to the case where each of the first current sensor 3a and the second current sensor 3b detects, of three-phase motor currents, U-phase and W phase motor currents, a combination of two-phase motor currents to be detected is not limited to the combination of the U-phase and W-phase motor currents. Additionally, although the above description is made with respect to the case where each of the first current sensor 3a and the second current sensor 3b detects two of three-phase motor currents, it may detect each of the three-phase motor currents.

Furthermore, in the configuration example as illustrated in FIG. 3, the subtracter 23 may be provided in the velocity controller 10, or the subtracters 23 and 24 may be provided in the velocity controller 10 or the current controller 11. The subtracters 21 and 25 may be provided in the compensator 16.

An example of hardware of the controller 5 as illustrated in FIG. 3 will be described. FIG. 4 is a hardware configuration diagram illustrating a configuration example of the controller as illustrated in FIG. 3. In the case where various functions of the controller 5 are fulfilled by hardware, the controller 5 as illustrated in FIG. 3 is a processing circuit 80 as illustrated in FIG. 4. The functions of the velocity controller 10, the current controller 11, the inverse coordinate transformer 12, the PWM signal generation unit 13, the coordinate transformer 14a, the coordinate transformer 14b, the position-velocity estimator 15a, the position-velocity estimator 15b, the compensator 16, and the subtracters 21 to 25 that are illustrated in FIG. 3 are fulfilled by the processing circuit 80.

In the case where each of the functions is fulfilled by hardware, the processing circuit 80 corresponds, for example, to a single circuit, a composite circuit, a programmed processor, a parallel programmed processor, an application specific integrated circuit (ASIC), a field-programmable gate array (FPGA), or a combination of these circuits. The functions of the velocity controller 10, the current controller 11, the inverse coordinate transformer 12, the PWM signal generation unit 13, the coordinate transformer 14a, the coordinate transformer 14b, the position-velocity estimator 15a, the position-velocity estimator 15b, the compensator 16, and the subtracters 21 to 25 may be fulfilled by respective processing circuits 80. Alternatively, the functions of the velocity controller 10, the current controller 11, the inverse coordinate transformer 12, the PWM signal generation unit 13, the coordinate transformer 14a, the coordinate transformer 14b, the position-velocity estimator 15a, the position-velocity estimator 15b, the compensator 16, and the subtracters 21 to 25 may be fulfilled by a single processing circuit 80.

Furthermore, an example of another hardware of the controller 5 as illustrated in FIG. 3 will be described. FIG. 5 is a hardware configuration diagram illustrating another configuration example of the controller as illustrated in FIG. 3. In the case where various functions of the controller 5 are fulfilled by software, the controller 5 as illustrated in FIG. 3 includes a processor 91 such as a CPU and a memory 92 as illustrated in FIG. 5. The functions of the velocity controller 10, the current controller 11, the inverse coordinate transformer 12, the PWM signal generation unit 13, the coordinate transformer 14a, the coordinate transformer 14b, the position-velocity estimator 15a, the position-velocity estimator 15b, the compensator 16, and the subtracters 21 to 25 are fulfilled by the processor 91 and the memory 92. FIG. 5 illustrates the processor 91 and the memory 92 that are connected to each other by a bus 93 such that they can communicate with each other.

In the case where each of the functions is fulfilled by software, the functions of the velocity controller 10, the current controller 11, the inverse coordinate transformer 12, the PWM signal generation unit 13, the coordinate transformer 14a, the coordinate transformer 14b, the position-velocity estimator 15a, the position-velocity estimator 15b, the compensator 16, and the subtracters 21 to 25 are fulfilled by software, firmware, or a combination of software and firmware. Software and firmware are written as programs and stored in the memory 92. The processor 91 reads out a program stored in the memory 92 and runs the program to fulfill the function of an associated one of the units.

As the memory 92, for example, a non-volatile semiconductor memory, such as a read only memory (ROM), a flash memory, an erasable and programmable ROM (EPROM), or an electrically erasable and programmable ROM (EEPROM), is used. Furthermore, as the memory 92, a volatile semiconductor memory, such as a random access memory (RAM), may be used. Additionally, as the memory 92, a removable recording medium, such as a magnetic disk, a flexible disk, an optical disc, a compact disc (CD), a MiniDisc (MD), or a digital versatile disc (DVD), may be used.

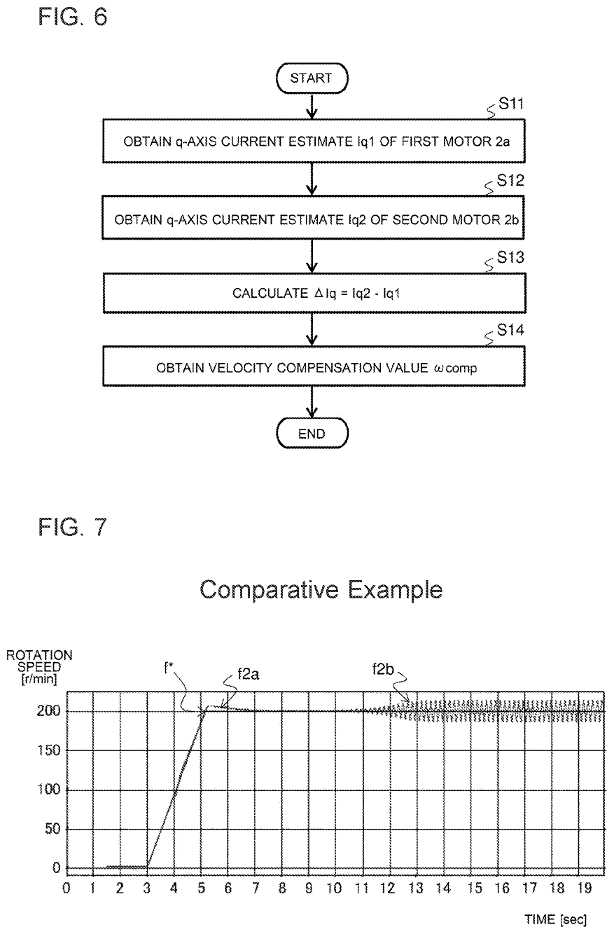

Next, a frequency compensation control method of the motor drive device 1 according to Embodiment 1 will be described. FIG. 6 is a flowchart indicating the procedure of the operation of the motor drive device according to Embodiment 1.

In step S11, the coordinate transformer 14a obtains a q-axis current estimate Iq1 of the first motor 2a by using an estimated phase θ1 of the first motor 2a and first current signals (Iu1, Iv1, Iw1). In step S12, the coordinate transformer 14b obtains a q-axis current estimate Iq2 of the second motor 2b by using an estimated phase θ2 of the second motor 2b and second current signals (Iu2, Iv2, Iw2). In step S13, the subtracter 25 calculates the result of equation ΔIq=Iq2−Iq1 by using the q-axis current estimates Iq1 and Iq2 to obtain a motor-to-motor current difference ΔIq.

In step S14, the compensator 16 obtains a velocity compensation value ωcomp by using the motor-to-motor current difference ΔIq. For example, when the motor-to-motor current difference ΔIq is positive, the compensator 16 sets the velocity compensation value ωcomp to a negative value. When the motor-to-motor current difference ΔIq is negative, the compensator 16 sets the velocity compensation value ωcomp to a positive value. The compensator 16 outputs the velocity compensation value ωcomp to the subtracter 21. The subtracter 21 subtracts the velocity compensation value ωcomp from the velocity command value ω* and outputs the result of the subtraction to the subtracter 22.

Although FIG. 6 indicates a procedure in which Iq1 is obtained in step S11 and then Iq2 is then obtained in step S12, the processes of steps S11 and S12 may be simultaneously carried out. The order in which steps S11 and S12 are carried out is not limited.

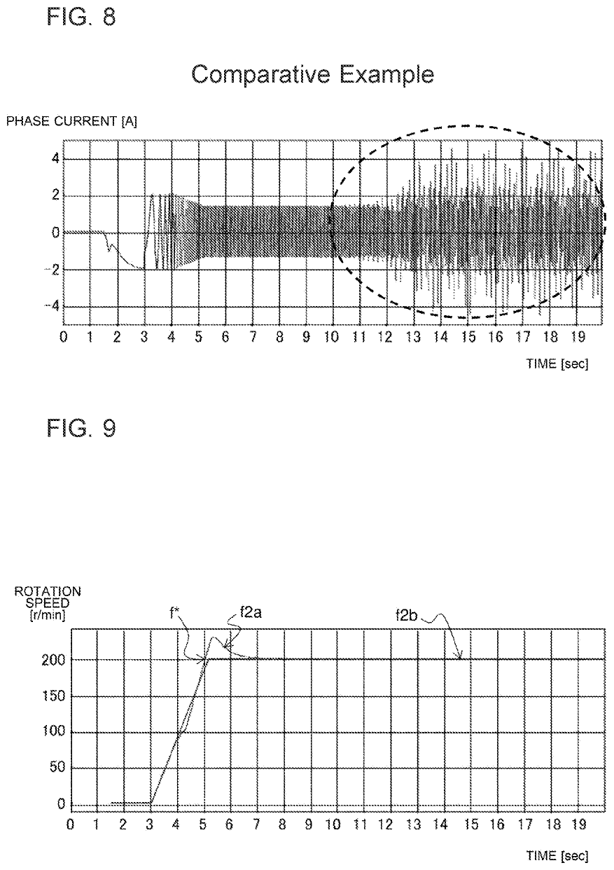

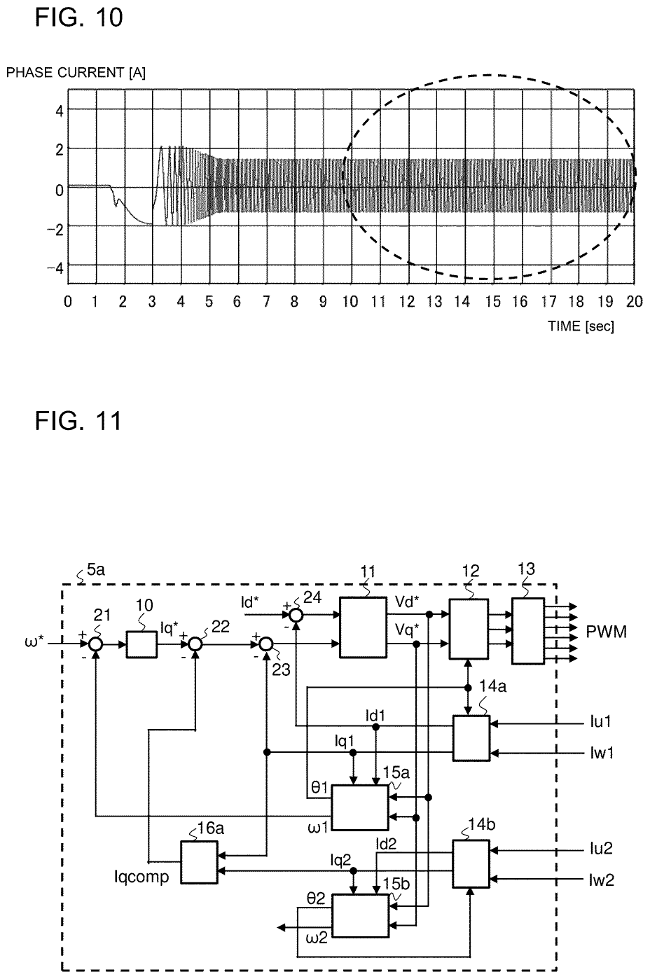

Next, advantages of the frequency compensation control by the motor drive device 1 according to Embodiment 1 will be described with reference to FIGS. 7 to 10. FIGS. 7 and 8 illustrate the case where the frequency compensation control according to Embodiment 1 is not applied. FIGS. 9 and 10 illustrate the case where the frequency compensation control according to Embodiment 1 is applied.

FIG. 7 is a graph illustrating the waveform of the frequency of a second motor under control in a comparative example. FIG. 8 is a graph illustrating the waveform of a phase current of the second motor under control in the comparative example. FIG. 9 is a graph illustrating the waveform of the frequency of the second motor under control according to Embodiment 1. FIG. 10 is a graph illustrating the waveform of a phase current of the second motor under control according to Embodiment 1.

In FIGS. 7 and 9, the vertical axis represents rotation speed [r/min] and the horizontal axis represents time [sec]. In FIGS. 7 and 9, a frequency command f* is a frequency corresponding to the velocity command value ω*, f2a is a frequency of the first motor 2a, and f2b is the frequency of the second motor 2b. In FIGS. 8 and 10, the vertical axis represents phase current [A] and the horizontal axis represents time [sec].

In the case where the frequency compensation control is not applied, as illustrated in FIG. 7, the second motor 2b is destabilized by electric spring resonance, and the frequency f2b of the second motor 2b is destabilized for the frequency command f*. As a result, phases of an applied voltage and an induced voltage are destabilized, and a current generated by a potential difference between the applied voltage and the induced voltage is also disturbed as indicated by an ellipse drawn with a dashed line in FIG. 8.

By contrast, in the case where the frequency compensation control is applied, the velocity compensation value ωcomp increases or decreases according to an increase or a decrease in q-axis current of the second motor 2b, and the phase difference between the first motor 2a and the second motor 2b decreases. Thus, as illustrated in FIG. 9, the first motor 2a and the second motor 2b operate such that the frequencies of the these motors coincide with the frequency command f*. As illustrated in FIG. 9, the rotation speeds of the first motor 2a and the second motor 2b are constant after an elapse of six seconds. As indicated by an ellipse drawn with a dashed line in FIG. 10, the waveform of the phase current of the second motor 2b is stabilized.

The motor drive device 1 according to Embodiment 1 includes the power converter 8 to which the first motor 2a and the second motor 2b are connected in parallel by the first conductive wire 6a and the second conductive wire 6b, the first current sensor 3a, the second current sensor 3b, and the controller 5 that controls the frequencies of the first motor 2a and the second motor 2b. The first current sensor 3a detects a first current signal indicating a current that flows to the first motor 2a. The second current sensor 3b detects a second current signal indicating a current that flows to the second motor 2b.

The controller 5 includes the coordinate transformers 14a and 14b and the compensator 16. The coordinate transformer 14a obtains a q-axis current estimate Iq1 that is an estimate of the torque current of the first motor 2a, by using first current signals (Iu1, Iv1, Iw1) and an estimated phase θ1 that is an estimate of the phase of the first motor 2a. The coordinate transformer 14b obtains a q-axis current estimate Iq2 that is an estimate of the torque current of the second motor, by using second current signals (Iu2, Iv2, Iw2) and an estimated phase θ2 that is an estimate of the phase of the second motor 2b. The compensator 16 compensates for the velocity command value ω* based on an estimated current difference between the q-axis current estimate Iq1 and the q-axis current estimate Iq2 to reduce the phase difference between the first motor 2a and the second motor 2b.

In Embodiment 1, when the velocity command value ω* is compensated for based on the estimated current difference between the q-axis current estimate Iq1 of the first motor 2a and the q-axis current estimate Iq2 of the second motor 2b, the phase difference between the first motor 2a and the second motor 2b that is made by loads is reduced. Thus, a phase shift of the second motor 2b relative to the first motor 2a is eliminated. In the second motor 2b, occurrence of disturbance in a phase current is reduced, and generation of a dead zone in a relationship between voltage and speed is reduced, improving the stability of the operation of the second motor 2b. In the second motor 2b, current pulsations are reduced, and highly robust operation can be achieved against disturbances, such as load variations.

For example, when the motor-to-motor current difference ΔIq is positive, the compensator 16 reduces the velocity command value ω*. When the motor-to-motor current difference ΔIq is positive, the load on the second motor 2b can be considered larger than that on the first motor 2a. Thus, when the output frequency of the inverter circuit 50 decreases, the phase of the second motor 2b the load on which is relative large is restored, and a phase lag of the second motor 2b is eliminated. By contrast, when the motor-to-motor current difference ΔIq is negative, the compensator 16 increases the velocity command value ω*. When the motor-to-motor current difference ΔIq is negative, the load on the second motor 2b can be considered smaller than that on the first motor 2a. Therefore, when the output frequency of the inverter circuit 50 increases, the phase of the first motor 2a the load on which is relatively large is restored, and a phase advance of the second motor 2b is eliminated.

Furthermore, a magnetic attractive force acts on a stator of an alternating-current motor, according to current amplitude. Thus, when the current amplitude increases, magnetic sound may give rise to a problem. In the drive system disclosed in Patent Literature 1, when the stability of current lowers, it causes an increase in current amplitude. Consequently, there is a possibility that sound and vibrations from the alternating-current motor will be increased. By contrast, in the motor drive device 1 according to Embodiment 1, the above frequency compensation control reduces current pulsations in the second motor 2b, and generation of sound and vibrations can be reduced. As a result, a plurality of motors can be caused to operate with less noise.

### Embodiment 2

Although regarding Embodiment 1, the above description concerning the frequency compensation method for the sub-motor is made with respect to the case where the velocity command value is compensated for, it is not limiting. In Embodiment 2, a q-axis current command value is compensated for, to thereby compensate for the frequency of the sub-motor. Regarding Embodiment 2, components that are the same as those in Embodiment 1 will be denoted by the same reference signs, and their detailed descriptions will thus be omitted.

A configuration of a motor drive device according to Embodiment 2 will be described. FIG. 11 is a block diagram illustrating a configuration example of a controller of the motor drive device according to Embodiment 2. As illustrated in FIG. 11, a controller 5a according to Embodiment 2 includes a compensator 16a that compensates for a q-axis current command value Iq*, in place of the compensator 16 as illustrated in FIG. 3. The compensator 16a has the function of the subtracter 25 as illustrated in FIG. 3. The compensator 16a outputs a q-axis current compensation value Iqcomp, which will be described later, to the subtracter 22.

In Embodiment 2, the coordinate transformer 14a outputs a q-axis current estimate Iq1 to the subtracter 23, the position-velocity estimator 15a, and the compensator 16a. The coordinate transformer 14b outputs a q-axis current estimate Iq2 to the position-velocity estimator 15b and the compensator 16a.

A configuration of the compensator 16a will be described in detail. The operation of the compensator 16a is represented, for example, by a transfer function G2(s) of Equation (2). In Equation (2), H(s) is a transfer function of the velocity controller 10.

$$Math . 2$$

$${G}_{2} ( s ) = {G}_{1} ( s ) H ( s ) \qquad ( 2 )$$

The transfer function expressed in Equation (2) is equivalent to the transfer function of Equation (1) described regarding Embodiment 1, and obviously, in Embodiment 2, similar advantages to those in Embodiment 1 can be obtained. The compensator 16a obtains, according to Equation (2), a q-axis current compensation value Iqcomp that compensates for the q-axis current command value Iq* on the basis of a motor-to-motor current difference ΔIq. The q-axis current compensation value Iqcomp is output from the compensator 16a to the subtracter 22. The subtracter 22 subtracts the q-axis current compensation value Iqcomp from the q-axis current command value Iq* output from the velocity controller 10. The result calculated by the subtracter 22 is a new q-axis current command value. The current controller 11 performs current control by using the new q-axis current command value.

For example, when the motor-to-motor current difference ΔIq is positive, load torque of the second motor 2b is larger than that of the first motor 2a, and it can be presumed that a rotational phase of the second motor 2b changes with a lag. It is possible to relatively eliminate a phase lag by reducing a frequency command of the inverter circuit 50. When the motor-to-motor current difference ΔIq is positive, the compensator 16a sets the q-axis current compensation value Iqcomp to a positive value. The q-axis current command value corresponds to a value that is obtained by reducing the q-axis current command value Iq* output from the velocity controller 10 by the q-axis current compensation value Iqcomp. When the q-axis current command value Iq* decreases, an output frequency of the inverter circuit 50 decreases. Since the load on the first motor 2a is smaller than that on the second motor 2b, the change of the phase of the first motor 2a is relatively small with reference to a variation in the output frequency of the inverter circuit 50. As a result, the difference between the phase of the second motor 2b and that of the first motor 2a decreases, and the phase lag of the second motor 2b is eliminated.

By contrast, when the motor-to-motor current difference ΔIq is negative, the load torque of the second motor 2b is smaller than that of the first motor 2a, and it can be presumed that a rotational phase of the second motor 2b relatively advances. When the motor-to-motor current difference ΔIq is negative, the compensator 16a sets the q-axis current compensation value Iqcomp to a negative value. The q-axis current command value corresponds to a value that is obtained by increasing the q-axis current command value Iq* output from the velocity controller 10 by the q-axis current compensation value Iqcomp. When the q-axis current command value Iq* increases, the output frequency of the inverter circuit 50 increases. Since the load on the second motor 2b is smaller than that on the first motor 2a, the change of the phase of the second motor 2b is relatively small with reference to a variation in the output frequency of the inverter circuit 50. As a result, the difference between the phase of the second motor 2b and the phase of the first motor 2a decreases, and a phase advance of the second motor 2b is eliminated.

It should be noted that in the configuration example as illustrated in FIG. 11, the subtracter 22 may be provided in the compensator 16a. Furthermore, the operation of the motor drive device 1 according to Embodiment 2 is the same as that in Embodiment 1 except for the process of step S14 in the procedure described with reference to FIG. 6 in Embodiment 1, and its detailed description will thus be omitted.

In Embodiment 2, the compensator 16a compensates for the q-axis current command value Iq* of the first motor 2a on the basis of an estimated current difference between the q-axis current estimate Iq1 and the q-axis current estimate Iq2 to reduce the phase difference between the first motor 2a and the second motor 2b. Therefore, a phase shift of the second motor 2b relative to the first motor 2a is eliminated, and similar advantages to those in Embodiment 1 can be obtained.

### Embodiment 3

In Embodiment 3, the phase of the primary motor is compensated for, to thereby eliminate a phase shift of the sub-motor. In Embodiment 3, components that are the same as those in Embodiments 1 and 2 will be denoted by the same reference signs, and their detailed descriptions will thus be omitted.

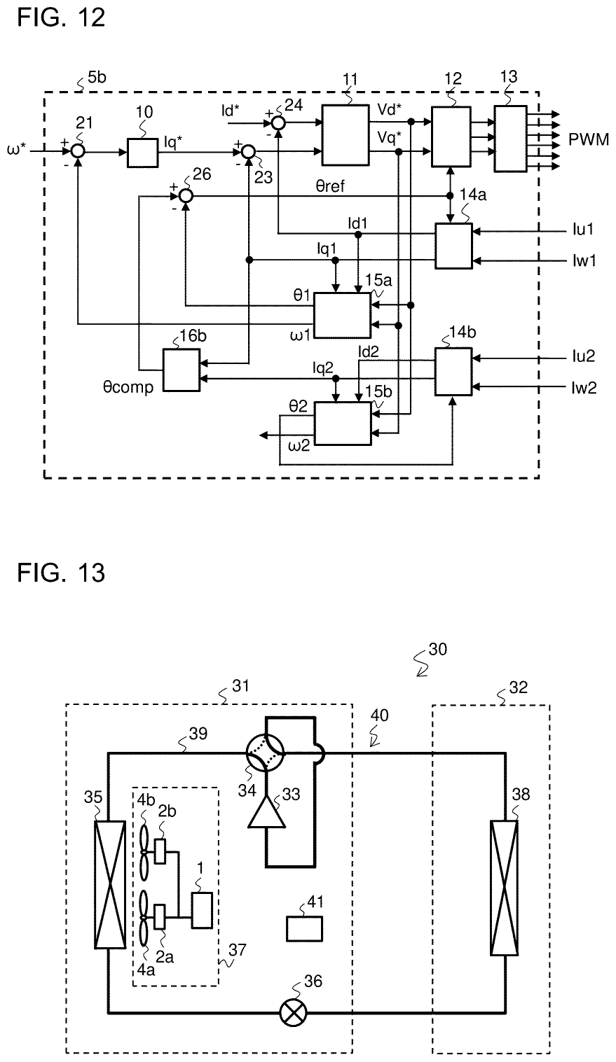

A configuration of the motor drive device according to Embodiment 3 will be described. FIG. 12 is a block diagram illustrating a configuration example of a controller of the motor drive device according to Embodiment 3. As illustrated in FIG. 12, a controller 5b according to Embodiment 3 includes a subtracter 26. Furthermore, the controller 5b includes a compensator 16b that compensates for the phase of the first motor 2a, in place of the compensator 16 as illustrated in FIG. 3. The compensator 16b has the function of the subtracter 25 as illustrated in FIG. 3. The compensator 16a outputs a phase compensation value θcomp, which will be described later, to the subtracter 26.

In Embodiment 3, the coordinate transformer 14a outputs a q-axis current estimate Iq1 to the subtracter 23, the position-velocity estimator 15a, and the compensator 16b. The coordinate transformer 14b outputs a q-axis current estimate Iq2 to the position-velocity estimator 15b and the compensator 16b. The position-velocity estimator 15a outputs an estimated phase θ1 to the subtracter 26.

The subtracter 26 receives the phase compensation value θcomp from the compensator 16b and receives the estimated phase θ1 from the position-velocity estimator 15a. The subtracter 26 subtracts the phase compensation value θcomp from the estimated phase θ1 to obtain an output voltage phase command θref. The subtracter 26 outputs the output voltage phase command θref to the inverse coordinate transformer 12 and the coordinate transformer 14a. The inverse coordinate transformer 12 receives the output voltage phase command θref from the subtracter 26. The inverse coordinate transformer 12 performs coordinate transformation of dq-axis voltage command values (Vd*, Vq*) into three-phase voltages (Vu, Vv, Vw) by using the output voltage phase command θref.

A configuration of the compensator 16b will be described in detail. The operation of the compensator 16b is expressed, for example, by a transfer function G3(s) in Equation (3). In Equation (3), H(s) is a transfer function of the velocity controller 10, and k is a constant.

$$Math . 3$$

$${G}_{3} ( s ) = {kG}_{1} ( s ) H ( s ) \qquad ( 3 )$$

The compensator 16b determines a difference between the phase of the first motor 2a and the phase of the second motor 2b on the basis of a motor-to-motor current difference ΔIq to obtain a phase compensation value θcomp corresponding to the result of the above determination. The phase compensation value θcomp is output from the compensator 16b to the subtracter 26. The phase compensation value θcomp applies negative compensation to the estimated phase θ1 corresponding to an output voltage phase command of the inverter circuit 50. To be more specific, the phase compensation value θcomp causes the estimated phase θ1 to lag when the motor-to-motor current difference ΔIq is positive and causes the estimated phase θ1 to advance when the motor-to-motor current difference ΔIq is negative. The compensator 16b does not directly compensate for the phase of the second motor 2b but indirectly compensates for the phase of the second motor 2b by finely adjusting the output voltage phase command of the inverter circuit 50.

The compensator 16b obtains a new output voltage phase command θref of the inverter circuit 50 by using the phase difference determined based on the motor-to-motor current difference ΔIq. Subsequently, the compensator 16b uses the obtained output voltage phase command Gref to cause the inverse coordinate transformer 12 to perform coordinate transformation of dq-axis voltage command values into three-phase voltages, and cause the coordinate transformer 14a to perform coordinate transformation of first current signals into dq-axis current values.

For example, when the load on the second motor 2b varies and the motor-to-motor current difference ΔIq is positive, the compensator 16b sets the phase compensation value θcomp to a positive value. In this case, the phase of the output voltage phase command θref lags behind the estimated phase θ1 by the phase compensation value θcomp. When the load on the second motor 2b increases, the actual phase of the second motor 2b thus lags, and the q-axis current estimate Iq2 increases, the output voltage phase command Gref of the inverter circuit 50 decreases. As a result, an increase in the load torque on the second motor 2b can be transiently reduced.

By contrast, when the load on the second motor 2b varies and the motor-to-motor current difference ΔIq is negative, the compensator 16b sets the phase compensation value θcomp to a negative value. In this case, the phase of the output voltage phase command θref advances from the estimated phase θ1 by the phase compensation value θcomp. When the load on the second motor 2b decreases, the actual phase of the second motor 2b advances, and the q-axis current estimate Iq2 decreases, the output voltage phase command θref of the inverter circuit 50 increases. As a result, a decrease in the load torque on the second motor 2b can be transiently reduced.

It should be noted that in the configuration example as illustrated in FIG. 12, the subtracter 26 may be provided in the compensator 16b. Furthermore, the operation of the motor drive device 1 according to Embodiment 3 is the same as in Embodiment 1 except for the process of step S14 in the procedure described with reference to FIG. 6 in Embodiment 1, and its detailed description will thus be omitted.

In Embodiment 3, the compensator 16b compensates for the estimated phase θ1 of the first motor 2a on the basis of an estimated current difference between the q-axis current estimate Iq1 and the q-axis current estimate Iq2 to reduce the phase difference between the first motor 2a and the second motor 2b. Therefore, a phase shift of the second motor 2b relative to the first motor 2a is eliminated, and the same advantages as in Embodiments 1 and 2 can be obtained.

### Embodiment 4

In Embodiment 4, the motor drive described regarding any one of Embodiments 1 to 3 is provided in an air-conditioning apparatus. Regarding Embodiment 4, components that are the same as those in Embodiments 1 to 3 will be denoted by the same reference signs, and their detailed descriptions will thus be omitted.

FIG. 13 is a refrigerant circuit diagram illustrating a configuration example of an air-conditioning apparatus according to Embodiment 4. As illustrated in FIG. 13, an air-conditioning apparatus 30 includes a heat-source-side unit 31, and a load-side unit 32.

The heat-source-side unit 31 includes a compressor 33 that compresses refrigerant and discharges the compressed refrigerant, a four-way valve 34 that switches the flow direction of the refrigerant between multiple flow directions, a heat-source-side heat exchanger 35 that causes heat exchange to be performed between refrigerant and outdoor air, an expansion valve 36 that decompresses the refrigerant to expand the refrigerant, an air-sending device 37, and a controller 41. The air-sending device 37 supplies outdoor air to the heat-source-side heat exchanger 35. The load-side unit 32 includes a load-side heat exchanger 38 that causes heat exchange to be performed between the refrigerant and air in an air-conditioning target space. In the air-conditioning target space, a temperature sensor (not illustrated) that detects the temperature of air is provided.

The compressor 33, the heat-source-side heat exchanger 35, the expansion valve 36, and the load-side heat exchanger 38 are connected by refrigerant pipes 39, whereby a refrigerant circuit 40 in which the refrigerant circulates is provided. The air-sending device 37 includes the first motor 2a to which the first fan 4a is connected, the second motor 2b to which the second fan 4b is connected, and the motor drive device 1 to which the first motor 2a and the second motor 2b are connected in parallel. The controller 41 is connected to the four-way valve 34, the compressor 33, the expansion valve 36, the temperature sensor (not illustrated), and the controller 5 (see FIG. 1) of the motor drive device 1 by signal lines (not illustrated).

The controller 41 is a controller that controls the air-conditioning apparatus 30. The controller 41 controls a refrigeration cycle of refrigerant that circulates in the refrigerant circuit 40. Specifically, the controller 41 controls an operating frequency of the compressor 33, an opening degree of the expansion valve 36, and a velocity command value ω* of the first motor 2a and the second motor 2b of the air-sending device 37 in such a manner as to cause the temperature of air in the air-conditioning target space to reach a set temperature determined in advance. When the air-conditioning apparatus 30 performs a cooling operation, the heat-source-side heat exchanger 35 operates as a condenser, and the load-side heat exchanger 38 operates as an evaporator. When the air-conditioning apparatus 30 performs a heating operation, the heat-source-side heat exchanger 35 operates as an evaporator, and the load-side heat exchanger 38 operates as a condenser.

The first fan 4a and the second fan 4b are installed in parallel, for example, in the same air passage in the heat-source-side unit 31. In this case, loads that act on the first motor 2a and the second motor 2b, respectively, are equalized, and the operations of these motors can be stabilized.

It should be noted that, although FIG. 13 illustrates a configuration in which the air-sending device 37 is provided in the heat-source-side unit 31, the air-sending device 37 may be provided in the load-side unit 32. In this case, the air-sending device 37 supplies air in the air-conditioning target space to the load-side heat exchanger 38.

In Embodiment 4, since the motor drive device 1 described regarding any of Embodiments 1 to 3 is used in the air-sending device 37, the first fan 4a and the second fan 4b can stably operate in synchronism with each other. For example, in the case where the air-sending device 37 supplies air to the heat-source-side heat exchanger 35, the entire heat-source-side heat exchanger 35 is supplied with a uniform volume of air, and the heat exchange efficiency of the heat-source-side heat exchanger 35 can thus be improved.

### REFERENCE SIGNS LIST

1: motor drive device, 2a: first motor, 2b: second motor, 3a: first current sensor, 3b: second current sensor, 4a: first fan, 4b: second fan, 5, 5a, 5b: controller, 6a: first conductive wire, 6b: second conductive wire, 7: signal line, 8: power converter, 9: alternating-current power supply, 10: velocity controller, 11: current controller, 12: inverse coordinate transformer, 13: PWM signal generation unit, 14a, 14b: coordinate transformer, 15a, 15b: position-velocity estimator, 16, 16a, 16b: compensator, 21 to 26: subtracter, 30: air-conditioning apparatus, 31: heat-source-side unit, 32: load-side unit, 33: compressor, 34: four-way valve, 35: heat-source-side heat exchanger, 36: expansion valve, 37: air-sending device, 38: load-side heat exchanger, 39: refrigerant pipe, 40: refrigerant circuit, 41: controller, 50: inverter circuit, 51d to 53d, 51u to 53u: switching element, 54: rectifier circuit, 55: capacitor, 80: processing circuit, 91: processor, 92: memory, 93: bus

1. A motor drive device configured to drive a first motor and a second motor, the motor drive device comprising:
a first current sensor configured to detect a first current signal indicating a current that flows to the first motor;
a second current sensor configured to detect a second current signal indicating a current that flows to the second motor;
a power converter to which the first motor and the second motor are connected in parallel, the power converter being configured to supply power to the first motor and the second motor; and
a controller configured to control the power converter by using a velocity command value, and control frequencies of the first motor and the second motor,
wherein the controller includes
a coordinate transformer configured to obtain a first q-axis current estimate that is an estimate of a torque current of the first motor, by using the first current signal and a first estimated phase that is an estimate of a phase of the first motor, and configured to obtain a second q-axis current estimate that is an estimate of a torque current of the second motor, by using the second current signal and a second estimated phase that is an estimate of a phase of the second motor, and
a compensator configured to compensate for the first estimated phase of the first motor on the basis of an estimated current difference between the first q-axis current estimate and the second q-axis current estimate to reduce a phase difference between the first motor and the second motor.

2. (canceled)

3. (canceled)

4. The motor drive device of claim 1,
wherein the controller includes
a velocity controller configured to obtain a q-axis current command value of the first motor that reduces a difference between the velocity command value input from outside and an estimated velocity that is an estimate of an angular velocity of the first motor,
a current controller configured to obtain a q-axis voltage command value that reduces a difference between the q-axis current command value and the first q-axis current estimate, and configured to obtain a d-axis voltage command value that reduces a difference between a d-axis current command value that is a command value of an exciting current of the first motor and a first d-axis current estimate that is an estimate of the exciting current of the first motor,
a position-velocity estimator configured to obtain the estimated velocity of the first motor and the first estimated phase of the first motor by using the d-axis voltage command value, the q-axis voltage command value, the first d-axis current estimate, and the first q-axis current estimate, and configured to obtain the second estimated phase by using the d-axis voltage command value, the q-axis voltage command value, the second q-axis current estimate, and a second d-axis current estimate, which is an estimate of an exciting current of the second motor, and
an inverse coordinate transformer configured to transform the d-axis voltage command value and the q-axis voltage command value into three-phase voltages by using the first estimated phase obtained by the position-velocity estimator,
wherein the coordinate transformer is configured to obtain the first d-axis current estimate by using the first estimated phase and the first current signal, and obtain the second d-axis current estimate by using the second estimated phase and the second current signal, and
wherein the compensator is configured to cause the first estimated phase to lag when a value of a motor-to-motor current difference is positive, and cause the first estimated phase to advance when the value of the motor-to-motor current difference is negative, the value of a motor-to-motor current difference being a value obtained by subtracting the first q-axis current estimate from the second q-axis current estimate.

5. The motor drive device of claim 1, wherein the controller is configured to control a frequency of the first motor through position sensorless vector control and subject a frequency of the second motor to compensation control by the compensator.

6. The motor drive device of claim 1, wherein the first motor and the second motor are permanent magnet synchronous motors.

7. An air-sending device comprising:
a first motor to which a first fan is coupled;
a second motor to which a second fan is coupled; and
the motor drive device of claim 1, the motor drive device being configured to drive the first motor and the second motor.

8. The air-sending device of claim 7, wherein the first fan and the second fan are installed in parallel in the same air passage.

9. An air-conditioning apparatus comprising:
a refrigerant circuit in which a compressor, a heat-source-side heat exchanger, an expansion valve, and a load-side heat exchanger are connected by refrigerant pipes and in which refrigerant circulates; and
the air-sending device of claim 7, the air-sending device being configured to supply air to at least one of the heat-source-side heat exchanger and the load-side heat exchanger.

10. A motor driving method using a motor drive device that includes: a power converter to which a first motor and a second motor are connected in parallel, the power converter being configured to supply power to the first motor and the second motor; a first current sensor configured to detect a first current signal indicating a current that flows to the first motor; and a second current sensor configured to detect a second current signal indicating a current that flows to the second motor, the motor drive device being configured to control the power converter by using a velocity command value and control frequencies of the first motor and the second motor, the motor driving method comprising:
obtaining a first q-axis current estimate that is an estimate of a torque current of the first motor, by using the first current signal and a first estimated phase that is an estimate of a phase of the first motor;
obtaining a second q-axis current estimate that is an estimate of a torque current of the second motor, by using the second current signal and a second estimated phase that is an estimate of a phase of the second motor; and
compensating for the first estimated phase of the first motor based on an estimated current difference between the first q-axis current estimate and the second q-axis current estimate to reduce a phase difference between the first motor and the second motor.
